(19) United States
(12) Patent Application Publication
(10) Pub. No.: US 2019/0114716 A1
(43) Pub. Date: Apr. 18, 2019

(54) METHODS FOR ANALYZING INSURANCE DATA AND DEVICES THEREOF

(71) Applicant: Mitchell International, Inc., San Diego, CA (US)

(72) Inventors: Abhijeet Gulati, San Diego, CA (US); Ravi Nemani, Carlsbad, CA (US); Eric Valenzuela, San Diego, CA (US); Scott Kozak, San Diego, CA (US)

(21) Appl. No.: 16/162,029

(22) Filed: Oct. 16, 2018

Related U.S. Application Data
(60) Provisional application No. 62/573,013, filed on Oct. 16, 2017.

(51) Int. Cl. G06Q 40/08; G06F 15/18; G06F 17/30; G06K 9/62

(52) U.S. Cl. CPC G06Q 40/08; G06F 15/18; G06K 9/6218; G06F 17/30991; G06F 17/30241

(57) ABSTRACT

Methods, non-transitory computer readable media, and computing apparatus that assist with analyzing data includes obtaining vehicle data from one of the plurality of data sources in a plurality of formats. The obtained vehicle data is aggregated based on one or more geographic locations obtained from one of the plurality of sources. A sampling threshold size is determined for sampling the aggregated vehicle data based on one or more threshold rules. One or more machine learning algorithms are applied to the aggregated vehicle data to generate sampling data when the aggregated vehicle data is greater than the determined sampling threshold size. The generated sampling data is represented in a graphical representation format via a graphical user interface.

This application claims the benefit of U.S. Provisional Patent Application Ser. No. 62/573,013, filed Oct. 16, 2017, which is hereby incorporated by reference in its entirety.

### FIELD

This technology generally relates to methods and devices for data management, more particularly, to methods for analyzing insurance data and devices thereof.

### BACKGROUND

Sales of different types of automobile insurance policies are influenced by various factors related to the vehicle, such as vehicle type, make, model, and year of manufacture. With prior existing technologies, there is no effective technological solution to compare the performance of one carrier to another to provide an unbiased and objective comparison of the insurance data considering all the aforementioned factors. In other words, prior existing technologies are currently unable to identify, obtain and sample data from the rest of the industry carriers in a manner where the sampled data shares the same characteristics of claims distribution for a given carrier whose performance needs to be compared and measured. Additionally, the data that is identified, obtained and sampled in the prior existing technologies does not accurately represent the data that is necessary to compare difference insurance carrier. As a result, the evaluation of the performance of the insurance carriers is inaccurate.

### SUMMARY

A method for analyzing data includes obtaining vehicle data from one of the plurality of data sources in a plurality of formats. The obtained vehicle data is aggregated based on one or more geographic locations obtained from one of the plurality of sources. A sampling threshold size is determined for sampling the aggregated vehicle data based on one or more threshold rules. One or more machine learning algorithms are applied to the aggregated vehicle data to generate sampling data when the aggregated vehicle data is greater than the determined sampling threshold size. The generated sampling data is represented in a graphical representation format via a graphical user interface.

A non-transitory computer readable medium having stored thereon instructions for analyzing data comprising machine executable code which when executed by at least one processor, causes the processor to obtain vehicle data from one of the plurality of data sources in a plurality of formats. The obtained vehicle data is aggregated based on one or more geographic locations obtained from one of the plurality of sources. A sampling threshold size is determined for sampling the aggregated vehicle data based on one or more threshold rules. One or more machine learning algorithms are applied to the aggregated vehicle data to generate sampling data when the aggregated vehicle data is greater than the determined sampling threshold size. The generated sampling data is represented in a graphical representation format via a graphical user interface.

An insurance data management computing apparatus including at least one of configurable hardware logic configured to be capable of implementing or a processor coupled to a memory and configured to execute programmed instructions stored in the memory to obtaining vehicle data from one of the plurality of data sources in a plurality of formats. The obtained vehicle data is aggregated based on one or more geographic locations obtained from one of the plurality of sources. A sampling threshold size is determined for sampling the aggregated vehicle data based on one or more threshold rules. One or more machine learning algorithms are applied to the aggregated vehicle data to generate sampling data when the aggregated vehicle data is greater than the determined sampling threshold size. The generated sampling data is represented in a graphical representation format via a graphical user interface.

This technology provides a number of advantages including providing a method, non-transitory computer readable medium, and apparatus that effectively assists with analyzing insurance and vehicle data. The disclosed technology is able to effectively use data from different insurance carriers in different formats to generate data that has been aggregated from accurate samples (or otherwise called synthetic peer data). Using the synthetic peer data, the disclosed technology is able to sample data with the clear understanding that the sampled data must share the same characteristics of claims distribution for a given carrier whose performance needs to be compared and measured against sample data from other carriers. Accordingly, the disclosed technology is able to consider parameters such as vehicle features and insurance claims data to compare the performance of one carrier to another and provide an unbiased comparison.

### BRIEF DESCRIPTION OF THE DRAWINGS

FIG. 1 is an example of a block diagram of an insurance data management computing apparatus for analyzing insurance data;

FIG. 2 is an example of a block diagram of an insurance data management computing apparatus;

FIG. 3 is an exemplary flowchart of a method for analyzing insurance data;

FIGS. 4A-4C are examples of generated synthetic peer data.

### DETAILED DESCRIPTION

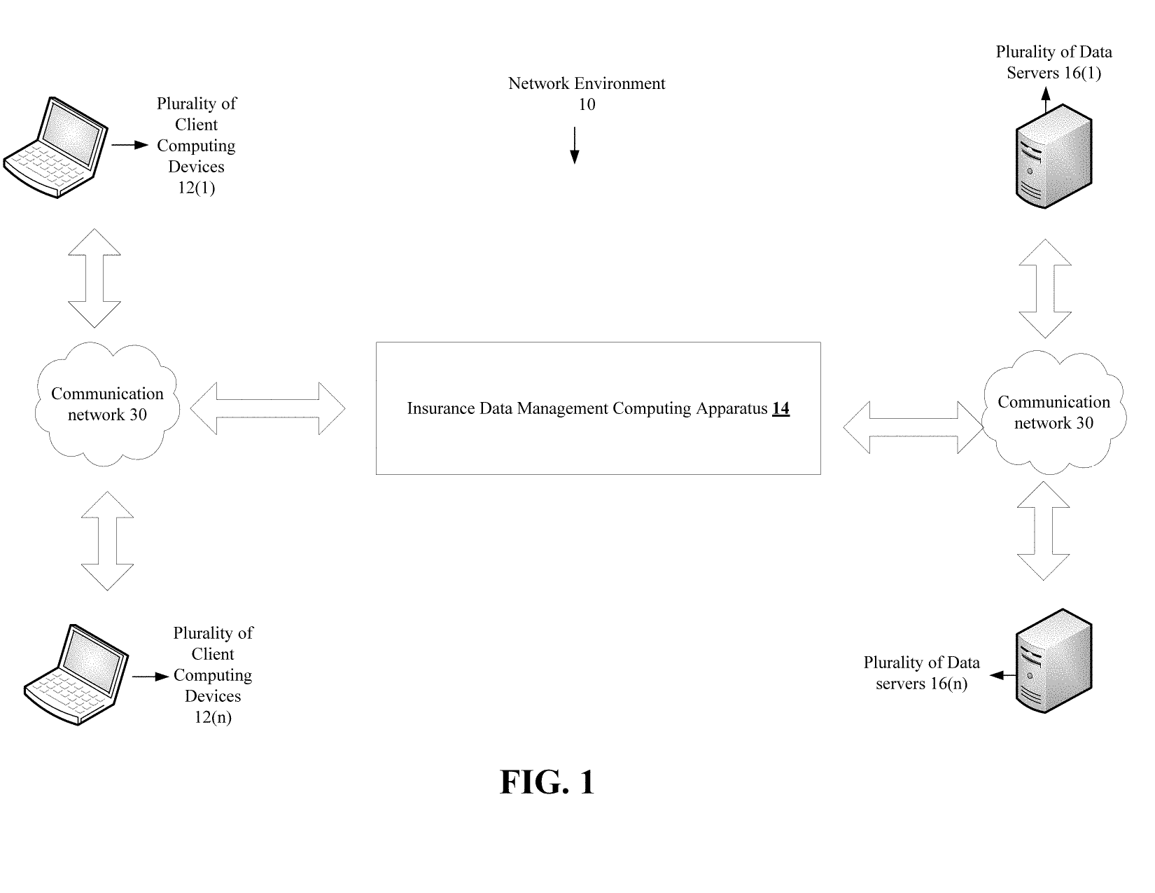

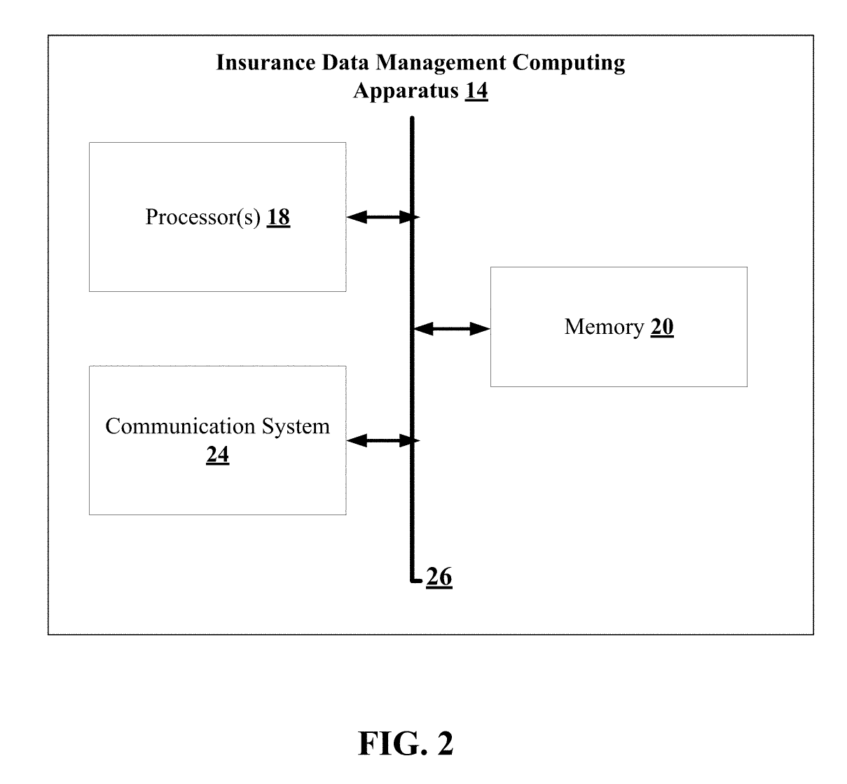

An environment 10 with an example of an insurance data management computing apparatus 14 is illustrated in FIGS. 1-2. In this particular example, the environment 10 includes the insurance data management computing apparatus 14, client computing devices 12(l)-12(n), plurality of data servers 16(l)-16(n) coupled via one or more communication networks 18, although the environment could include other types and numbers of systems, devices, components, and/or other elements as is generally known in the art and will not be illustrated or described herein. This technology provides a number of advantages including providing methods, non-transitory computer readable medium, and apparatuses to analyze insurance data. The disclosed technology is able to effectively use data from different insurance carriers in different formats to generate data that has been aggregated from accurate samples (or otherwise called synthetic peer data). Using the synthetic peer data, the disclosed technology is able to sample data with the clear understanding that the sampled data must share the same characteristics of claims distribution for a given carrier whose performance needs to be compared and measured against sample data from other carriers. Accordingly, the disclosed technology is able to consider parameters such as vehicle features and insurance claims data to compare the performance of one carrier to another and provide an unbiased comparison.

Referring more specifically to FIGS. 1-2, the insurance data management computing apparatus 14 is programmed to perform efficient methods to analyze insurance data, although the apparatus can perform other types and/or numbers of functions or other operations and this technology can be utilized with other types of claims. In this particular example, the insurance data management computing apparatus 14 includes a processor 18, a memory 20, and a communication system 24 which are coupled together by a bus 26, although the insurance data management computing apparatus 14 may comprise other types and/or numbers of physical and/or virtual systems, devices, components, and/or other elements in other configurations.

The processor 18 in the insurance data management computing apparatus 14 may execute one or more programmed instructions stored in the memory 20 for improving the accuracy of automated vehicle valuations as illustrated and described in the examples herein, although other types and numbers of functions and/or other operations can be performed. The processor 18 in the insurance data management computing apparatus 14 may include one or more central processing units and/or general purpose processors with one or more processing cores, for example.

The memory 20 in the insurance data management computing apparatus 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication system 24 in the insurance data management computing apparatus 14 operatively couples and communicates between one or more of the client computing devices 12(l)-12(n) and one or more of the plurality of data servers 16(l)-16(n), which are all coupled together by one or more of the communication networks 30, although other types and numbers of communication networks or systems with other types and numbers of connections and configurations to other devices and elements may be utilized. By way of example only, the communication networks 18 can use TCP/IP over Ethernet and industry-standard protocols, including NFS, CIFS, SOAP, XML, LDAP, SCSI, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the client computing devices 12(l)-12(n) may submit requests for analyzing insurance data by the insurance data management computing apparatus 14, although the requests for analyzing insurance data can be obtained by the insurance data management computing apparatus 14 in other manners and/or from other sources. Each of the client computing devices 12(l)-12(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements.

The plurality of data servers 16(l)-16(n) may store and provide data associated with different insurance carriers, by way of example only, to the insurance data management computing apparatus 14 via one or more of the communication networks 30, for example, although other types and/or numbers of storage media in other configurations could be used. In this particular example, each of the plurality of data servers 16(l)-16(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the plurality of data servers 16(l)-16(n) and may transmit data in response to requests from the insurance data management computing apparatus 14. Each the plurality of data servers 16(l)-16(n) may include a processor, a memory, and a communication interface, which are coupled together by a bus or other link, although each may have other types and/or numbers of other systems, devices, components, and/or other elements.

Although the exemplary network environment 10 with the insurance data management computing apparatus 14, the agent computing devices 12(l)-12(n), the plurality of data servers 16(l)-16(n), and the communication networks 30 are described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

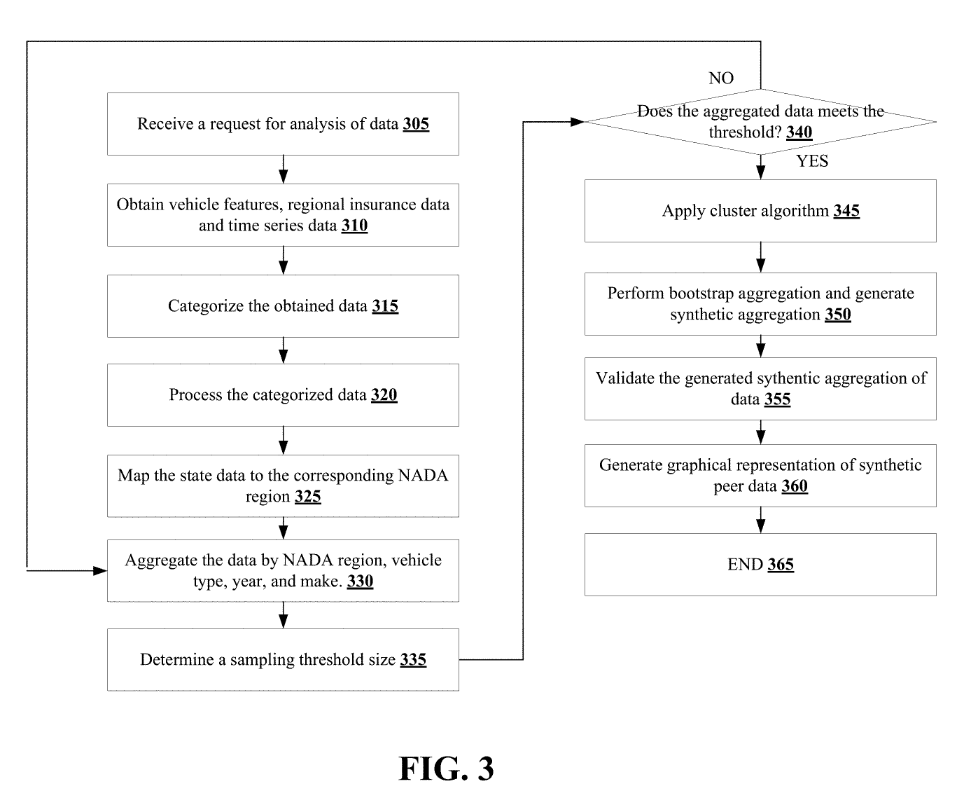

An example of a method for analyzing insurance data will now be described with reference to FIGS. 1-4C. In particular, referring to FIGS. 3A-3C the exemplary method begins at step 305 where the insurance data management computing apparatus 14 may integrate with at least one insurance claim application executed by a requesting one of the plurality of client computing devices 12(l)-12(n) to initiate analysis of insurance data of various carriers.

In step 310, the insurance data management computing apparatus 14 obtains vehicle features data, regional insurance claims data as well as time series data associated with multiple insurance carriers from the plurality of data servers 16(l)-16(n) in response to the request, although the insurance data management computing apparatus 14 can obtain different types of data from different data sources. By way of example, the vehicle features includes but not limited to data associated with type, make, model and year of a vehicle, the regional insurance claims data including but not limited to the demographic regions and the ZIP codes, and the time series data including the data indexed based on the time series data which include day, week, month, quarter, and year, although the vehicle feature data, regional insurance data and the time series data can include other types or amounts of information such as like vehicle identification number data (or VIN), or demographic data including longitude latitude data. In this example, time series data relates to the insurance data points that has been recorded over a period of time. By way of example, time series data can include the data relating to the total losses recorded on each day of the year, although the time series data can include other types of information.

In step 315, the insurance data management computing apparatus 14 categorizes the obtained data for each of the obtained insurance carriers. In this example, the insurance data management computing device categorizes the data based on the vehicle identification number, vehicle region, vehicle make, vehicle model, vehicle year and vehicle type along with the company code, although the data can be filtered based on other parameters. By categorizing the data, the disclosed technology is able to have the right set of quality data to run a statistical comparison.

Next in step 320, the insurance data management computing apparatus 14 processes the categorized data by removing invalid data or data with certain null values. By way of example, the insurance data management computing apparatus 14 can remove data with missing or default service codes, remove data when the service code, time period, or total estimate amount are unknown, and remove data when the estimates amount is zero dollars. Furthermore, the insurance data management computing apparatus 14 removes the statistical outlier from the categorized data.

In step 325, the insurance data management computing apparatus 14 maps the each state information present in the categorized vehicle features data, regional insurance claims data as well as time series data associated with multiple insurance carriers to a specific geographic region. By way of example, the insurance data management computing apparatus 14 can map the state data to their corresponding national automobile dealers association (NADA) region, although the insurance data management computing apparatus 14 can map the state data to a specific geographic region based on other parameters.

In step 330, the insurance data management computing apparatus 14 aggregates the data based on the specific geographic region and other parameters including the vehicle, type, year, and make, although the insurance data management computing apparatus 14 can aggregate the data using other parameters.

In step 335, the insurance data management computing apparatus 14 determines a sampling threshold size based on one or more threshold rules, although the insurance data management computing device 14 can determine the claims threshold value using other techniques. By way of example only, the threshold rules can include: the data must not reduce significantly i.e., it must be more than at least 25%; data must be big enough to do a statistical comparison typically at least more than 30; and the data must not be synthetically imputed in any way and must adhere to available industry wide data, although other types and additional rules can be included.

Next in step 340, the insurance data management computing apparatus 14 determines if the aggregated data is equal to the determined sampling threshold size. In this example, the insurance data management computing apparatus 14 determines if the distribution is equal to the determined sampling threshold size to ensure that there is appropriate size of sample data available for processing. Accordingly, when the insurance data management computing apparatus 14 determines that the distribution is not equal to the determined sampling threshold size, then the No branch is taken to step 339 where the aggregation of the data is reconsidered. However, if the insurance data management computing apparatus 14 determines that the distribution is equal to the determined threshold value, then the Yes branch is taken to step 345. In this example, determining whether the aggregated data is equal to the determined sampling threshold size is important because the insurance data management computing apparatus 14 can aggregate sufficient data necessary for accurately generating statistical data for comparison.

In step 345, the insurance data management computing apparatus 14 applies one or more cluster algorithms on the aggregated data. By way of example, the insurance data management computing apparatus 14 can apply bootstrap aggregation as one of the cluster algorithms, although the insurance data management computing apparatus 14 can apply other types of cluster algorithms. By applying one of the data clustering algorithms, the disclosed technology is able to cluster the aggregated data based on the vehicle data, demographic data and time series data, although the data can be clustered into different models.

In step 350, the insurance data management computing apparatus 14 performs bootstrap aggregation on the aggregated data to select the samples of data from the aggregated data to generate data that can be used for comparison (or otherwise called synthetic peer data). In this example, bootstrap aggregation relates to applying algorithms to improve the stability and accuracy of the data while performing analytics. Further, the synthetic aggregation of data that is generated includes a portion of the data that was obtained in the step 310 and the data then is ready for applying the statistical model and comparing to another data set. By way of example, the synthetic aggregation of data can include data associated with the model, make, year of the vehicle, the geographical location of the vehicle (or the vehicle region) and the time series data of the vehicle for a specific insurance carrier, although the synthetic aggregation data can include other types or amounts of information.

Next in step 355, the insurance data management computing apparatus 14 validates the generated synthetic aggregation of data. By way of example, the insurance data management computing apparatus 14 performs a statistical T-test validation within each strata of the synthetical aggregation to make sure sample represent the actual population, although the insurance data management computing apparatus 14 can use other techniques for data validation. In this example, only an exact equality will lead to a p-value of 1.0, which is conforming to each strata of the sample that represents the actual population. Optionally in this example, when the data validation fails, the exemplary flow can proceed back to step 335 where the sampling threshold size can be redetermined.

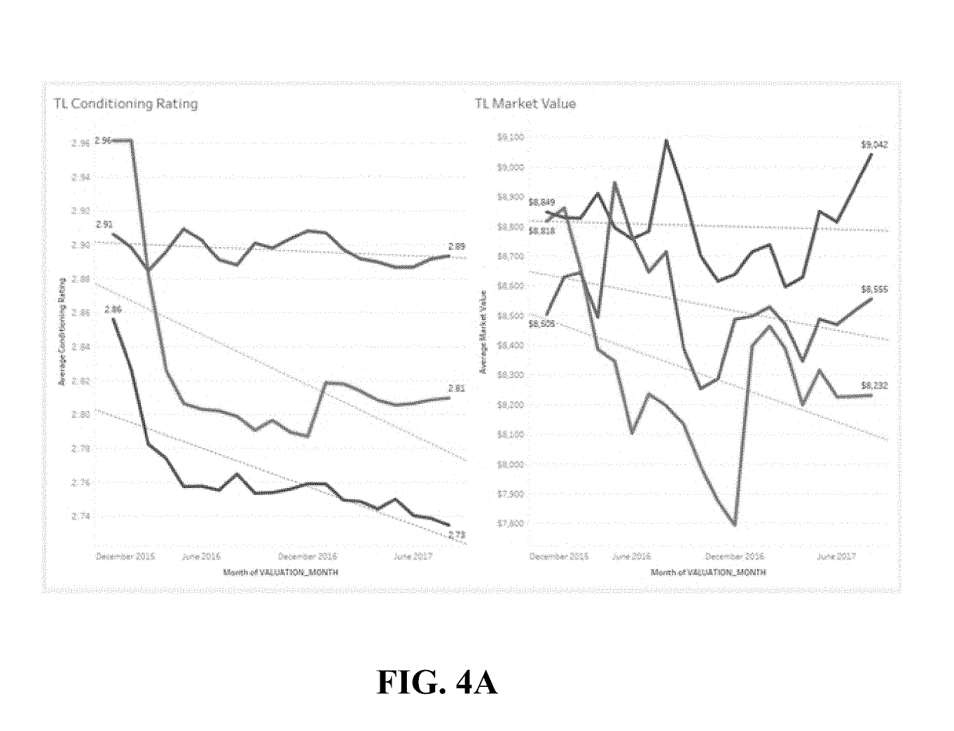

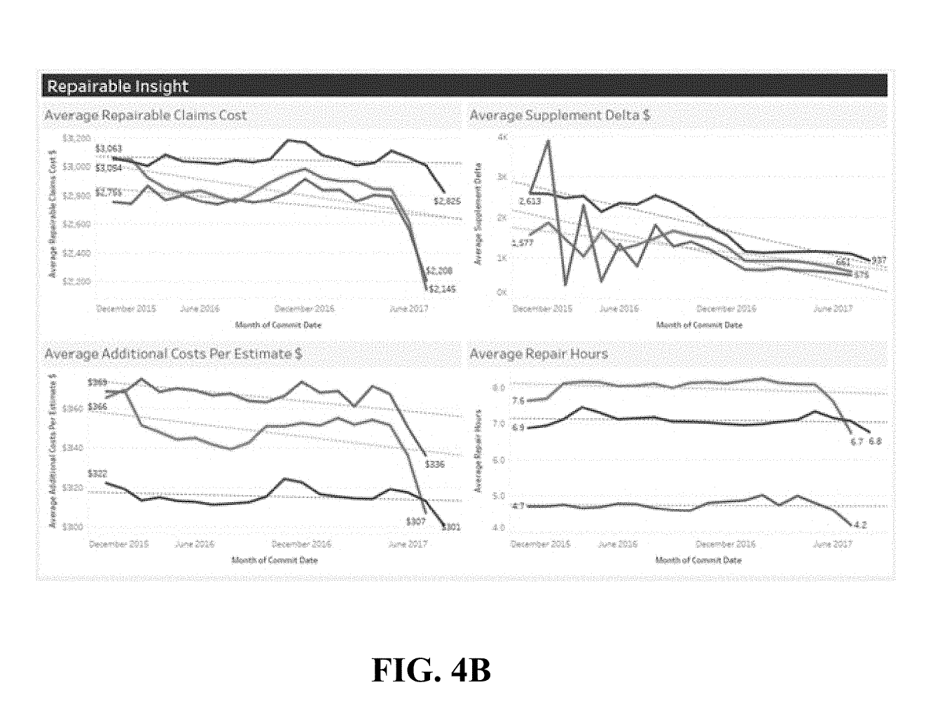

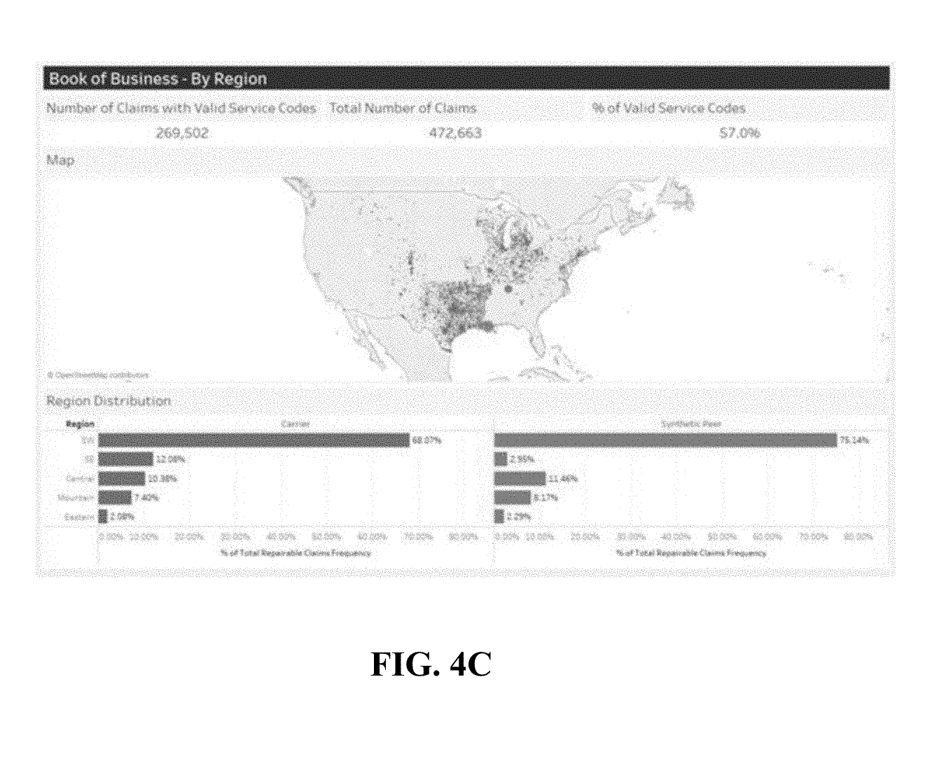

In step 360, the insurance data management computing apparatus 14 generates a graphical representation of the generated synthetic peer data. In this example, the graphical representation can include the insights of the synthetic aggregation of the data, although the graphical representation can include other types or amounts of information. In this example, FIGS. 4A-4C illustrates a graphical representation of the generated synthetic peer data. Additionally in this example, the synthetic peer data that is generated is transferred to a cache memory within the memory 20 and the graphical representation is created based on the data in the cache memory. By using this technique, the disclosed technology is able to provide a faster and real-time representation of the data without latency. The exemplary method ends at step 365.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for analyzing data comprising:
obtaining, by an insurance data management computing apparatus, vehicle data from one of the plurality of data sources in a plurality of formats;
aggregating, by the insurance data management computing apparatus, the obtained vehicle data based on one or more geographic location data obtained from one of the plurality of sources;
determining, by the insurance data management computing apparatus, a sampling threshold size for sampling the aggregated vehicle data based on one or more threshold rules;
applying, by the insurance data management computing apparatus, one or more machine learning algorithms to the aggregated vehicle data to generate sampling data when the aggregated vehicle data and the associated demographic vehicle data is greater than the determined sampling threshold size; and
representing, by the insurance data management computing apparatus, the generated sampling data in a graphical representation format via a graphical user interface.

2. The method as set forth in claim 1 further comprising, categorizing, by the insurance data management computing apparatus, the obtained vehicle data based on one or more data categorizing rules.

3. The method as set forth in claim 1 further comprising, performing, by the insurance data management computing apparatus, a data cluster operation on the aggregated data prior to applying the one or more machine learning algorithms when the aggregated vehicle data is greater than the determined sampling threshold size.

4. The method as set forth in claim 1 further comprising, performing, by the insurance data management computing apparatus, data validation to the generated sample data.

5. The method as set forth in claim 1 wherein the generated sample data is stored in a cache memory.

6. The method as set forth in claim 5 wherein the sample data is obtained from the cache memory to generated the graphical representation.

7. A non-transitory computer readable medium having stored thereon instructions for analyzing data, comprising executable code, which when executed by at least one processor, cause the processor to:
obtain vehicle data from one of the plurality of data sources in a plurality of formats;
aggregate the obtained vehicle data based on one or more geographic location data obtained from one of the plurality of sources;
determine a sampling threshold size for sampling the aggregated vehicle data based on one or more threshold rules;
apply one or more machine learning algorithms to the aggregated vehicle data to generate sampling data when the aggregated vehicle data and the associated demographic vehicle data is greater than the determined sampling threshold size; and
represent the generated sampling data in a graphical representation format via a graphical user interface.

8. The medium as set forth in claim 7 further comprises categorize the obtained vehicle data based on one or more data categorizing rules.

9. The medium as set forth in claim 7 further comprises, perform a data cluster operation on the aggregated data prior to applying the one or more machine learning algorithms when the aggregated vehicle data is greater than the determined sampling threshold size.

10. The medium as set forth in claim 7 further comprises, perform data validation to the generated sample data.

11. The medium as set forth in claim 7 wherein the generated sample data is stored in a cache memory.

12. The medium as set forth in claim 11 wherein the sample data is obtained from the cache memory to generated the graphical representation.

13. An insurance data management computing apparatus comprising:
a processor; and
a memory coupled to the processor which is configured to be capable of executing programmed instructions comprising and stored in the memory to:
obtain vehicle data from one of the plurality of data sources in a plurality of formats;
aggregate the obtained vehicle data based on one or more geographic location data obtained from one of the plurality of sources;
determine a sampling threshold size for sampling the aggregated vehicle data based on one or more threshold rules;
apply one or more machine learning algorithms to the aggregated vehicle data to generate sampling data when the aggregated vehicle data and the associated demographic vehicle data is greater than the determined sampling threshold size; and
represent the generated sampling data in a graphical representation format via a graphical user interface.

14. The apparatus as set forth in claim 13 wherein the processor is further configured to be capable of executing the stored programmed instructions to categorize the obtained vehicle data based on one or more data categorizing rules.

15. The apparatus as set forth in claim 13 wherein the processor is further configured to be capable of executing the stored programmed instructions to perform a data cluster operation on the aggregated data prior to applying the one or more machine learning algorithms when the aggregated vehicle data is greater than the determined sampling threshold size.

16. The apparatus as set forth in claim 13 wherein the processor is further configured to be capable of executing the stored programmed instructions to perform data validation to the generated sample data.

17. The apparatus as set forth in claim 13 wherein the generated sample data is stored in a cache memory.

18. The apparatus as set forth in claim 17 wherein the sample data is obtained from the cache memory to generated the graphical representation.
